(19) United States
(12) Patent Application Publication
(10) Pub. No.: US 2025/0148800 A1
(43) Pub. Date: May 8, 2025

(54) METHOD AND APPARATUS WITH MULTI-FEATURE OBJECT DETECTION

(71) Applicant: Samsung Electronics Co., Ltd., Suwon-si (KR)

(72) Inventors: Solae LEE, Suwon-si (KR); Park SEUNGIN, Suwon-si (KR); Hyeongseok SON, Suwon-si (KR); Byung In YOO, Suwon-si (KR); Minki JEONG, Suwon-si (KR)

(73) Assignee: Samsung Electronics Co., Ltd., Suwon-si (KR)

(21) Appl. No.: 18/636,331

(22) Filed: Apr. 16, 2024

(30) Foreign Application Priority Data
Nov. 3, 2023 (KR) 10-2023-0151054

(51) Int. Cl. G06V 20/58; G01S 17/86; G01S 17/89; G01S 17/931; G06V 10/40; G06V 10/80

(52) U.S. Cl. CPC G06V 20/58; G01S 17/86; G01S 17/89; G01S 17/931; G06V 10/40; G06V 10/806

(57) ABSTRACT

An object detection method and an object detection apparatus for detecting an object based on multi-features are provided. The object detection method includes: obtaining first-sensor data from a first sensor and obtaining second-sensor data from a second sensor, wherein the first sensor is a different type of sensor than the second sensor; extracting a first feature from the first-sensor data and extracting a second feature from the second-sensor data; determining a target feature-type by inputting the first and second features to a feature-type selection model which, based thereon, predicts the target feature-type; determining a target feature to be used for object detection according to the determined target feature-type; and determining an object detection result based on the determined target feature.

### CROSS-REFERENCE TO RELATED APPLICATIONS

This application claims the benefit under 35 USC § 119 (a) of Korean Patent Application No. 10-2023-0151054, filed on Nov. 3, 2023, in the Korean Intellectual Property Office, the entire disclosure of which is incorporated herein by reference for all purposes.

### BACKGROUND

### 1. Field

The following description relates to a method and apparatus with multi-feature object detection.

### 2. Description of Related Art

With the recent convergence of information and communication technology and the automobile industry, there has been rapid smartization of automobiles. Due to smartization, automobiles have advanced from simple mechanical machines to smart cars, and advanced driver assistance systems (ADAS) and autonomous driving have been sought after as the core technology of smart cars.

ADAS and autonomous driving require technology for recognizing a driving environment, such as lanes, surrounding vehicles, or pedestrians, technology for determining a driving situation, control technology, such as acceleration/deceleration, or other various technologies. To implement these technologies, it is necessary to accurately and efficiently recognize or detect objects surrounding a vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an object detection method includes: obtaining first-sensor data from a first sensor and obtaining second-sensor data from a second sensor, wherein the first sensor is a different type of sensor than the second sensor; extracting a first feature from the first-sensor data and extracting a second feature from the second-sensor data; determining a target feature-type by inputting the first and second features to a feature-type selection model which, based thereon, predicts the target feature-type; determining a target feature to be used for object detection according to the determined target feature-type; and determining an object detection result based on the determined target feature.

The first sensor may be an image capturing device configured to output image data as the first-sensor data, and the second sensor may be a light detection and ranging (LiDAR) or RADAR sensor configured to output point cloud data as the second-sensor data.

The feature-type selection model may be configured to, based on the first feature that is input to the feature-type selection model and the second feature that is input to the feature-type selection model, output selection data controlling selection of: object detection using the first feature and not the second feature, object detection using the second feature and not the first feature, and object detection using the first feature with the second feature.

The feature-type selection model may be configured to, based on the first feature that is input to the feature-type selection model and the second feature that is input to the feature-type selection model, output probability values of a first and second feature-type, respectively, the first feature-type corresponding to performing object detection using the first feature and not the second feature, and the second feature-type corresponding to performing object detection using the second feature and not the first feature.

The method may further include selecting, as the target feature-type, from among the first and second feature-types, whichever has the greatest among the probability values.

The determining the object detection result may include: selecting, from among a first candidate object detection result determined based on the first feature and not the second feature, and a second candidate object detection result determined based on the second feature and not the first feature.

The method may further include: based on the determining of the target feature-type: generating a third feature by synthesizing or combining the first feature with the second feature as the target feature.

The object detection result from the object detection model may be obtained by inputting the determined target feature to an object detection model based on the object detection model corresponding to the target feature-type.

The determining of the object result based on the determined target feature may include: selecting, as the object detection result, between (i) a first object detection result inferred by a first object detection model from the first feature but not from the second feature and (ii) a second object detection result inferred by a second object detection model from the second feature but not from the first feature.

In another general aspect, an object detection apparatus may include: one or more processors; and a memory storing instructions configured to cause the one or more processors to: obtain first-sensor data from a first sensor and obtain second-sensor data from a second sensor that is a different type of sensor than the first sensor; extract a first feature from the first-sensor data but not from the second-sensor data, and extract a second feature from the second-sensor data but not from the first-sensor data; determine a target feature-type through a feature-type selection model having the first feature and the second feature as an input; determine a target feature to be used for object detection according to the determined target feature-type; and determine an object detection result based on the determined target feature

The first sensor may be an image capturing device configured to output image data as the first sensor data, and the second sensor may be a light detection and ranging (LiDAR) or RADAR sensor configured to output point cloud data as the second sensor data.

The feature-type selection model may be configured to, based on the first feature that is input to the feature-type selection model and the second feature that is input to the feature-type selection model with the first feature, output selection data controlling selection of: object detection using the first feature and not the second feature, and object detection using the second feature and not the first feature.

The feature-type selection model may be configured to, based on the first feature that is input to the feature-type selection model and the second feature that is input to the feature-type selection model, output data indicating probability values of a first and second feature-type, respectively, the first feature-type corresponding to performing object detection using the first feature and not the second feature, and the second feature-type corresponding to performing object detection using the second feature and not the first feature.

The instructions may be further configured to cause the one or more processors to select, as the target feature-type, from among the first and second feature-types, whichever has the greatest among the probability values.

The instructions may be further configured to cause the one or more processors to select between a first candidate object detection result determined based on the first feature and not the second feature, and a second candidate object detection result determined based on the second feature and not the first feature.

The instructions may be further configured to cause the one or more processors to, based on the determining of the target feature-type, generate a third feature by synthesizing or combining the first feature with the second feature as the target feature.

The object detection result from the object detection model may be obtained by inputting the determined target feature to an object detection model based on the object detection model corresponding to the determined target feature-type.

In another general aspect, a vehicle system includes: a first sensor configured to obtain image data capturing an area near a vehicle; a second sensor configured to radiate electromagnetic energy in the area near the vehicle and obtain point cloud data based on a reflection of the electromagnetic energy from an object in the area; and one or more processors configured to detect the object based on the image data and the point cloud data by: extracting a first feature from the image data and extracting a second feature from the point cloud data; performing a first inference, by a first object detection model, on the first feature but not on the second feature, to generate a first object detection result; performing a second inference, by a second object detection model, on the second feature but not on the first feature, to generate a second object detection result; input the first feature with the second feature to a selection model, the selection model inferring an output from the first feature and the second feature; and based on the output, select between the first object detection result and the second object result as an object detection result corresponding to the object.

The output of the selection model may include a first probability value corresponding to the first object detection model and a second probability value corresponding to the second object detection model, wherein whichever of the first and second object detection results' object detection model has the higher probability value is selected as the object detection result.

The one or more processors may be further configured to perform a third inference, by a third object detection model, on a combination or synthesis of the first feature with the second feature, to generate a second object detection result; and the selecting based on the output may include selecting between the first, second, and third object detection results.

Other features and aspects will be apparent from the following detailed description, the drawings, and the claims.

### BRIEF DESCRIPTION OF THE DRAWINGS

FIG. 1 illustrates an example of a vehicle system including an object detection apparatus, according to or more embodiments.

FIG. 2 illustrates example operations for training a feature-type selection model, according to one or more embodiments.

FIG. 3 illustrates an example training process of the feature-type selection model, according to one or more embodiments.

FIG. 4 illustrates an example of a configuration of a training device for training the feature-type selection model, according to one or more embodiments.

FIG. 5 illustrates an example object detection method, according to one or more embodiments.

FIG. 6 illustrates an example of determining an object detection result by using the feature-type selection model, according to one or more embodiments.

FIG. 7 illustrates an example of a configuration of the object detection apparatus, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

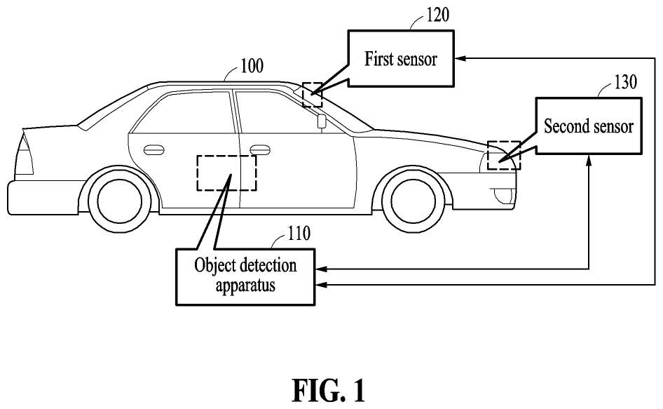

FIG. 1 illustrates an example of a vehicle system including an object detection apparatus, according to one or more embodiments.

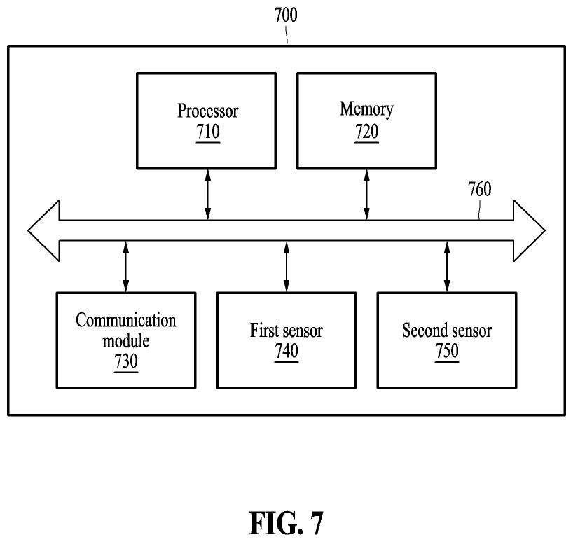

Referring to FIG. 1, a vehicle 100 may be controlled through a vehicle system. The vehicle system may include an object detection apparatus 110 (e.g., an object detection apparatus 700 of FIG. 7), which is an apparatus for detecting an object in a vicinity or surrounding area (e.g., a front area, a rear area, or a side area) of the vehicle 100. In this case, the object, as a target of recognition or detection, may be, for example, a person, another vehicle, a nearby building, a crosswalk, a road facility, or a traffic light. The “object” may also be referred to herein as a “3-dimensional (3D) object”. Object detection performed by the object detection apparatus 110 may include object recognition for recognizing what the object is, e.g., determining a class or type of the object.

The vehicle system may include sensors for sensing the surrounding area of the vehicle 100 (the surrounding area need not be a full perimeter). The sensors may include a first sensor 120 (e.g., a first sensor 740 of FIG. 7) and a second sensor 130 (e.g., a second sensor 750 of FIG. 7). The first sensor 120 may obtain image data capturing the surrounding area of the vehicle 100. The second sensor 130 may radiate a laser in the surrounding area of the vehicle 100 and obtains point cloud data (or laser data) based on light of the laser that is reflected from an object. The point cloud data may include a set cloud of points scattered across a 3D space. The first sensor 120 may be an image acquisition device, such as a camera, and the second sensor 130 may be a light detection and ranging (LiDAR) sensor. The LIDAR sensor may include a transmission antenna, a reception antenna, and a processing unit. The transmission antenna transmits a laser pulse, and the reception antenna receives the laser pulse as reflected from an object. The processing unit obtains distance and position values (points) of the object based on the received reflected laser pulse. The first sensor 120 and the second sensor 130 may be spaced apart from each other or adjacent to each other in the vehicle 100. The first sensor 120 and the second sensor 130 may be used to detect objects that are in the same area in the surrounding area of the vehicle 100 (i.e., sensing ranges of the first sensor 120 and the second sensor 130 may overlap). Types of sensors other than image acquisition devices and LiDAR sensors may be used. For example, the vehicle system may include a radio detection and ranging (RADAR) sensor that transmits a radio frequency (RF) signal and obtains distance and position values (e.g., 3D points) of an object based on receiving the RF signal as reflected from the object.

The object detection device 110 may perform object detection by determining and selecting an optimal modality from among modalities available in the vehicle system for detecting objects based on sensor data obtainable from sensors (including the first sensor 120 and the second sensor 130). Each modality may be a method of the object detection apparatus 110 that uses the feature of sensor data to perform object detection. For example, the modalities for detecting objects may include a method of detecting an object by using a first feature of first-sensor data obtained from the first sensor 120, a method of detecting an object by using a second feature of second-sensor data obtained from the second sensor 130, and a method of detecting an object by using both the first feature and the second feature. The object detection apparatus 110 may perform object detection by selectively using a modality to be used for the object detection among the modalities.

In object detection, when there are multiple types of sensors whose data may be used for object detection, the accuracy of object detection using one or the other may vary depending on driving situations. There may be a modality whose suitability for object detection varies depending on situations. For example, when the vehicle 100 is in a dark environment, the first-sensor data (e.g., image data) obtained by the first sensor 120 may be noisy or an object in the image data may not be readily identifiable. In this case, the accuracy of object detection may increase when using the second feature extracted from the second-sensor data (e.g., point cloud data) of the second sensor 130 compared to when using the first feature extracted from the first-sensor data. When the first-sensor data is obtained in the dark environment and includes much noise, the first feature extracted from the first-sensor data may include much inaccurate information, which may decrease the accuracy of object detection. When the vehicle 100 is in a rainy or snowy environment, the second-sensor data obtained from the second sensor 130 may include much noise from the rain or snow. In this case, the accuracy of object detection may increase when using the first feature extracted from the first-sensor data compared to when using the second feature extracted from the second-sensor data. When the second-sensor data obtained in the snowy or rainy environment includes much noise, the second feature extracted from the second-sensor data may include much inaccurate information, which may decrease the accuracy of object detection. When the vehicle 100 is in a bright environment without rain or snow, the accuracy of object detection may increase when using both the first feature and the second feature. In this case, noise is less likely to be included in the first feature and the second feature, the first-sensor data and the second-sensor data are less likely to decrease the accuracy of object detection, and all useful information available from the first-sensor data and the second-sensor data may be used for object detection.

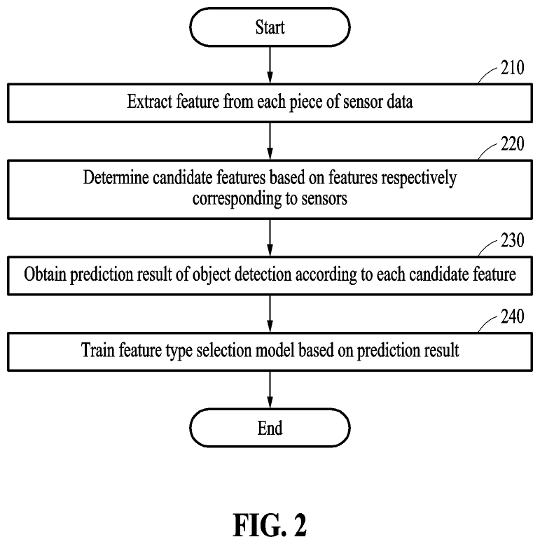

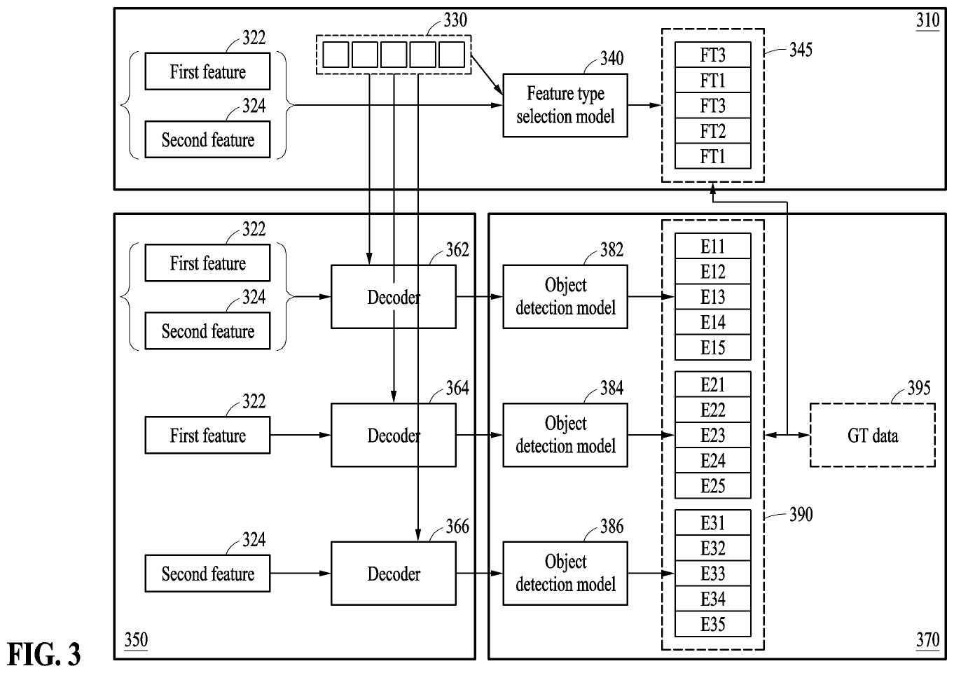

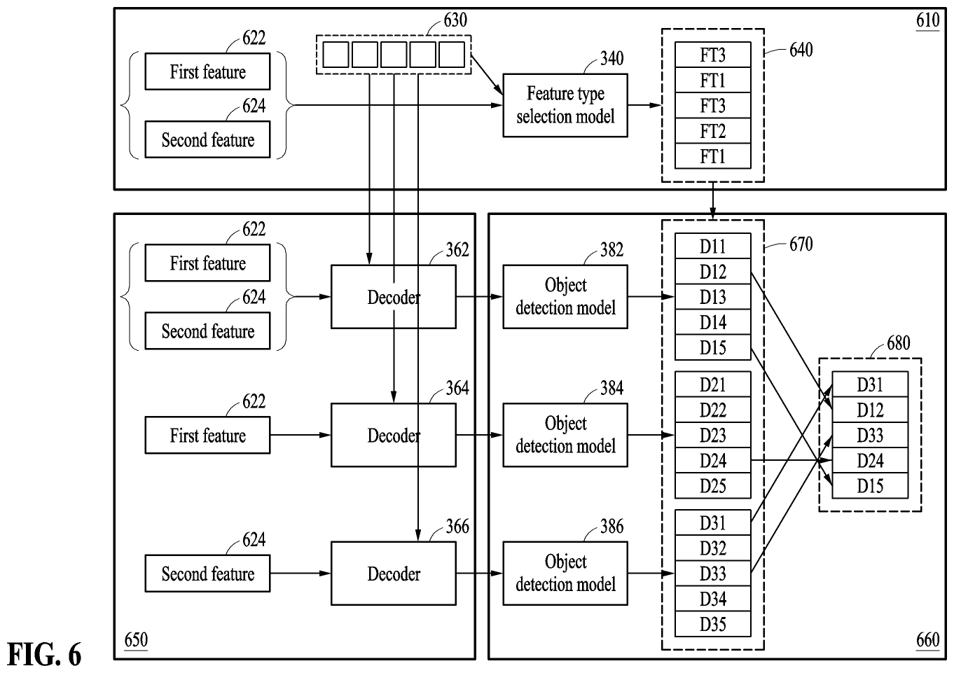

In an embodiment, the object detection apparatus 110 may include a processor (e.g., a processor 710 of FIG. 7), and the processor may detect an object in the surrounding area of the vehicle 100, based on the first-sensor data (e.g., image data) obtained from the first sensor 120 and the second-sensor data (e.g., point cloud data) obtained from the second sensor 130. The processor may extract the first feature from the image data and may extract the second feature from the point cloud data. The processor may determine a target feature-type (one of which may be combination of feature-types) through a feature-type selection model (e.g., a feature-type selection model 340 shown in FIGS. 3 and 6). The feature-type selection model may receive the first feature and the second feature as inputs and may determine (e.g., infer), as an output, a target feature-type that is to be used for object detection. The processor may determine an object detection result about the surrounding area of the vehicle 100 based on the determined target feature-type. The target feature-type may correspond to the modality described above, and the feature-type selection model may be trained through a training process, which is described with reference to FIGS. 2 to 4. The process of the object detection apparatus 110 detecting an object is described below.

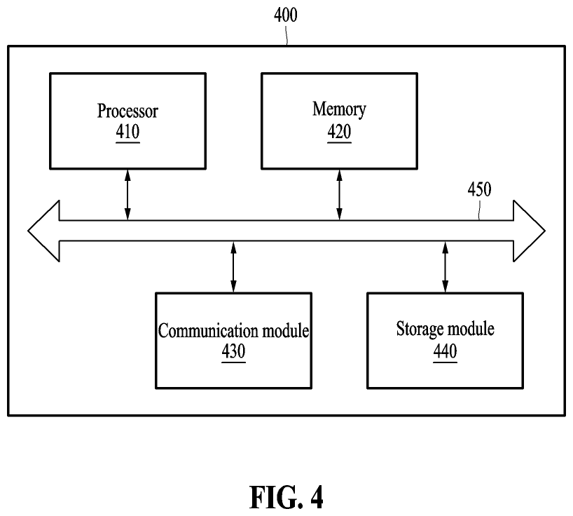

FIG. 2 illustrates an example of training a feature-type selection model, according to one or more embodiments. The training method may be performed by a training device (e.g., a training device 400 of FIG. 4) described herein.

Referring to FIG. 2, in operation 210, the training device may extract a feature from each piece of sensor data of respective types of sensors. The sensor data used for training may be referred to as training data. The training device may use features of respective modalities. For example, the training device may extract a feature from image data obtained by an image acquisition device and may extract a feature from point cloud data obtained by a LiDAR sensor. The feature of the image data may be an edge, a straight line, a circle, a rim, a corner, a Haar feature, a histogram of oriented gradients (HOG) feature, a scale-invariant feature transform (SIFT) feature, a speeded-up robust feature (SURF), or a combination thereof, to name some non-limiting examples. The feature of the image data may be extracted by using a feature extractor, which may be implemented, for example, as a neural network (e.g., a convolutional neural network). Alternatively, the image data may be input to an encoder and a vector value of a vector output from the encoder may be used as the training feature of the image data. The feature of the point cloud data may be a voxel-based feature or a feature extracted by using a neural network feature extractor, but examples are not limited thereto. The point cloud data may be input to an encoder of a transformer model and a vector value output from the encoder may be used as the feature of the point cloud data.

In operation 220, the training device may determine candidate features based on features respectively corresponding to different types of sensors. The training device may generate candidate features that are determined for each of the respective modalities (e.g., object detection with one feature, the other, or both). The candidate features may include a feature generated by combining (or synthesizing) features, e.g., the features extracted respectively from pieces of sensor data of different types of sensors (combining may be a concatenation of the features). For example, under the assumption that features generally usable for object detection include a first feature and a second feature, the candidate features may include the first feature, the second feature, and a third feature that is generated by combining the first feature and the second feature. A method of using only the first feature may correspond to a first modality, a method of using only the second feature may correspond to a second modality, and a method of using the third feature (a hybrid of the first and second features) may correspond to a third modality. If the number of types of features (e.g., of respective types of sensors) usable for object detection is N, the number of possible modalities or the number of possible candidate features may be 2^{N}−1. That is, depending on implementation, all unique combinations of features (including singular) of respective sensor types may be candidate features. As another example, if N is 3 and the 3 sensors are a camera (C), a LiDAR (L), and a RADAR (R), there may be 7 candidate features: C, L, R, C-L, C-R, L-R, and C-L-R.

In operation 230, the training device may obtain (e.g., infer) prediction results of object detection according to the respective candidate features. The training device may obtain the object detection prediction results based on the candidate features of the respective modalities. More specifically, the modalities may have respectively corresponding object detection models, each configured to output prediction results of object detection for its corresponding candidate feature (here, “candidate feature” also refers to a feature combination). For example, there may be an object detection model to which the first feature is input, an object detection model to which the second feature is input, and an object detection model to which the third feature (the combination of the first feature and the second feature) is input. Each object detection model may be a neural network that outputs the prediction results of object detection based on a corresponding feature inputted thereto. Each object detection model's prediction result (of object detection) may include information on a probability value about whether a feature that is input to the object detection model is related to an object trait, category, class, etc. (or probabilities of respective categories/classes of an object).

In operation 240, the training device may train the feature-type selection model (e.g., the feature-type selection model 340 of FIG. 3) based on the prediction result of object detection obtained in operation 230. When multiple features extracted from various respective types of sensor data are given (e.g., for a training sample), which feature or which combination of features has the most advantageous effect in predicting object detection (or which modality has the highest accuracy of prediction) may be determined (for the sample) through a loss value obtained by comparing a prediction result of object detection by each modality with a ground truth (GT) (of the training sample). Based on which of the modalities has the smallest respective loss, a modality label that should be selected (for the training sample) by the feature-type selection model from among various possible modalities may be determined (the modality label indicating one of the modalities that is best for the training sample). This process may be performed for multiple training samples.

In one or more embodiments, the first feature and the second feature are assumed to be usable for object detection. In this case, the first modality is the method of detecting an object by using only the first feature, the second modality is the method of detecting an object by using only the second feature, and the third modality is the method of detecting an object using a third feature, i.e., a combination/synthesis of both the first feature and the second feature. Prediction results of object detection models may be obtained by the first modality, the second modality, and the third modality, respectively. The modality having the prediction result whose difference with the GT is the smallest may be selected. Assuming, for a given training sample, that the prediction result of the second modality has the smallest difference with the GT, a label may be selected which indicates that the feature-type selection model should select the second feature (corresponding to the second modality) as a target feature-type to be used for object detection (for the given training sample). The label may be used as the GT in training the feature-type selection model. The training device may train the feature-type selection model (for the given training sample) by using the selected label. The feature-type selection model may determine which target feature-type should be used for object detection with the first feature and the second feature as inputs. The feature-type selection model may include or may be a neural network.

The training device may optimize the feature-type selection model based on an objective function. The objective function may be a loss function or a cost function. The training device may (for the given training sample) (i) calculate a loss between the target feature-type determined by the feature-type selection model and the label determined above and (ii) may train the feature-type selection model based on the calculated loss. The training process may include updating parameters (e.g., weights) of the feature-type selection model through an error backpropagation algorithm such that a loss decreases.

Based on pieces of sensor data, the training device may perform the training process described above continuously and repeatedly for pieces of training data of any sensor that has a GT modality (or feature-type).

FIG. 3 illustrates an example of training the feature-type selection model, according to one or more embodiments.

FIG. 3 illustrates a process of training the feature-type selection model, which operates in an object detection structure and which may be implemented as a transformer model (a neural network architecture). The feature-type selection model 340 and decoders 362, 364, and 366 may operate in the transformer model, and the transformer model may provide a prediction result related to object detection corresponding to the number of queries 330 in one frame. The queries 330 may be, for example, a 1D vector and may include information on a certain object. As described below, in the example of FIG. 3, decoders 362, 364, and 366 may respectively correspond to feature-types FT1, FT2, and FT3. The training process illustrated in FIG. 3 may be performed by the training device (e.g., the training device 400 of FIG. 4) described herein.

The training process of the feature-type selection model may include processes 310, 350, and 370, with which the feature-type selection model 340 (i) in process 310, determines a target feature-type 345 based on features 322 and 324 extracted from training data (e.g., labeled training sensor data), (ii) in process 350, generates candidate features based on the features 322 and 324, and (iii) in process 370, determines a prediction result 390 of object detection corresponding to each candidate feature by using object detection models 382, 384, and 386 and trains the feature-type selection model 340 based on the prediction result 390 and GT data 395. As described below, in the example of FIG. 3, object detection models 382, 384, and 386 may respectively correspond to feature-types FT1, FT2, and FT3. For description, it may be assumed that a feature of image data obtained from an image acquisition device corresponds to a first feature 322, a feature of point cloud data obtained from a LIDAR sensor corresponds to a second feature 324, and only an image feature corresponding to the first feature 322 and a LIDAR feature corresponding to the second feature 324 are used. However, these are non-limiting examples; the types of features are not limited to the image feature and the LiDAR feature.

In process 310, keys respectively corresponding to the queries 330, the first and second features 322, 324, and values associated respectively with the keys may be input to the feature-type selection model 340. The queries may be for different GT objects associated with a training sample. The feature-type selection model 340 may predict the target feature-type (or a target modality) 345 by the queries 330, as inferred based on the first feature 322 and the second feature 324, and output an indication of the prediction. The feature-type selection model 340 may receive different types of features of a training sample (e.g., the first feature 322 and the second feature 324) and predict a target feature-type, which is a feature-type that the model has estimated to have an advantageous effect in object detection (or to have the highest accuracy of a prediction result of object detection). The target feature-type (or the target modality) may be used for object detection among the different types of features. The feature-type selection model 340 may determine, for example, whether to use only the first feature 322, only the second feature 324, or both the first feature 322 and the second feature 324 for object detection and may output a determined result as the target feature-type 345.

For example, the feature-type selection model 340 may determine and output any one of the target feature-types for each query. The feature-type selection model 340 may output 1 for a feature-type determined to be the target feature-type and may output 0 for the rest of the feature-types. More specifically, for each query, the feature-type selection model 340 may output probability values respectively corresponding to feature-types (including the combined first-second feature-type). Each probability value may be a degree to which a prediction result of object detection according to each feature-type should be reflected in a final prediction result. The target feature-type 345 that is output from the feature-type selection model 340 may include target feature-types determined for the respective queries 330. For example, for a first query, feature-type FT3 in the first (top) place of the target feature-type 345 indicates that the feature-type selection model 340 has determined that a modality for using only the second feature 324 for object detection will be the target feature-type for the first query. For the second query, feature-type FT1 in the second place of the target feature-type 345 indicates that the feature-type selection model 340 has determined that a modality using both the first feature 322 and the second feature 324 for object detection will be a target feature-type for the second query. For a fourth query, feature-type FT2 in the fourth place of the target feature-type 345 indicates that the feature-type selection model 340 has determined that a modality using only the first feature 322 for object detection will be the target feature-type for a fourth query.

In process 350, various candidate features may be generated for respective queries of a training sample. There may be the decoders 362, 364, and 366 of which the number is less than or equal to the number of feature-types (or modality types). The decoders 362, 364, and 366 may be decoders of the transformer model. The queries 330 may each be inputted to each of the decoders 362, 364, and 366, and a feature corresponding to a feature-type of each of the decoders 362, 364, and 366 may be input thereto. The keys respectively corresponding to the first feature 322 and the second feature 324 and the values associated respectively with the keys may be input to the decoder 362, and a candidate feature of a feature-type using the first feature 322 and the second feature 324 may be output from the decoder 362. The candidate feature generated by combining or synthesizing the first feature 322 with the second feature 324 may be output by the decoder 362. The key corresponding to the first feature 322 and the value associated with the key may be input to the decoder 364, and a candidate feature of a feature-type using only the first feature 322 (without using the second feature 324) may be output from the decoder 364. The key corresponding to the second feature 324 and the value associated with the key may be input to the decoder 366, and a candidate feature of a feature-type using only the second feature 324 (without using the first feature 322) may be output from the decoder 366.

In process 370, candidate features (or feature-types) output respectively from the decoders 362, 364, and 366 may be input respectively to the object detection models 382, 384, and 386. Each of the object detection models 382, 384, and 386 may output the prediction result 390 of object detection based on the respectively input candidate features. The prediction result 390 may include, for example, prediction information of the classification of objects and/or an object area. Based on the prediction result 390, a position of object area (e.g., an object bounding box) and/or object classification may be estimated.

Each of the object detection models 382, 384, and 386 may be a neural network trained to output a prediction result related to object detection based on the respectively input candidate features, but a range of embodiments is not limited thereto (in the case of the object detection model 382 for the combined/synthesized feature, the object detection model may be configured to infer on both types of feature data, e.g., image feature data and point cloud feature data). Each of the object detection models 382, 384, and 386 may be configured and used for each task that may be performed in object detection. Tasks may include, for example, object classification, object velocity prediction, or object position/size/direction prediction (here, “tasks” indicates that each task that may be performed in object detection, as noted above). The decoders 362, 364, and 366 may be commonly used regardless of the type of task, or decoders may be provided and used for each task. When the decoders 362, 364, and 366 are commonly used, the decoders 362, 364, and 366 may have the same structure. In some implementations, the decoder 362 may be configured to receive the first and second features 322, 324 and combine them during the decoding process (e.g., their concatenation may be decoded). In another implementation, the first and second features 322, 324 may be combined (e.g., a weighted combination, averaged, etc.) and then passed to the decoder 362 as a single input. This may be possible if the first feature and second features 322, 324 have the same dimension and represent the same feature space.

The example shown in FIG. 3 assumes that: the object detection model 382 outputs prediction results {E11, E12, E13, E14, E15} respectively for the input queries 330; the object detection model 384 outputs prediction results {E21, E22, E23, E24, E25} for the input queries 330; and the object detection model 386 outputs prediction results {E31, E32, E33, E34, E35} for the input queries 330. The prediction results {E11, E12, E13, E14, E15}, {E21, E22, E23, E24, E25}, and {E31, E32, E33, E34, E35} may respectively correspond to prediction results obtained for the feature-types (modalities) FT1, FT2, and FT3. Each of sets {E11, E21, E31}, {E12, E22, E32}, {E13, E23, E33}, {E14, E24, E34}, and {E15, E25, E35} may be prediction results predicted for the respective queries 330.

The prediction results 390 that are output from the object detection models 382, 384, and 386 may be compared with the GT data 395 (of the current training sample being processed), and a loss that each feature-type has for each query may be calculated. The GT data 395 may include information on an object detection result predetermined for each query. A feature-type having the smallest loss among feature-types (e.g., the feature-types FT1, FT2, and FT3) selectable by the feature-type selection model 340 may be determined to be a target feature-type that a feature-type selection model should select. The target feature-type determined as such may be used as a label for the training of the feature-type selection model 340. To do so, a hard label formed as a one-hot vector may be used, in which a feature-type having the smallest loss is set to 1 and the other feature-types are set to 0. For another example, a probability value based on a relative rate between losses determined for respective feature-types may also be used as a label. To do so, a soft label method may be used, in which probability values are divided and assigned based on the relative rate between the losses. When a loss determined for a feature-type is relatively small, a high probability value may be assigned to the feature-type.

The example of FIG. 3 assumes that a loss of the prediction results E31 and E33 (corresponding to the feature-type FT3) is the smallest for the first query and the third query, a loss of the prediction results E12 and E15 (corresponding to the feature-type FT1) is the smallest for the second query and the fifth query, and the prediction result E24 (corresponding to the feature-type FT2) is the smallest for the fourth query. In this case, according to the hard label method, the feature-type selection model 340 may determine respective labels of the feature-types FT3, FT1, FT3, FT2, and FT1 in this order for the five queries, like the target feature-type 345. The training device may compare the target feature-type 345 for each query based on the first feature 322 and the second feature 324 with the determined label corresponding to the query. The training device may calculate a loss between the target feature-type determined by the feature-type selection model 340 and the label determined above and may train the feature-type selection model 340 based on the calculated loss. The training device may train the feature-type selection model 340 such that the labels determined above may be output for the first feature 322 and the second feature 324 that are input to the feature-type selection model 340.

The above process may be performed on other first features and other second features continuously and repeatedly (e.g., for other training samples).

FIG. 4 illustrates an example configuration of a training device for training the feature-type selection model, according to one or more embodiments.

Referring to FIG. 4, the training device 400 may be configured for training any of the feature-type selection models (e.g., the feature-type selection model 340 of FIG. 3) described herein. The training device 400 may include a processor 410, a memory 420, a communication module 430, and a storage module 440, and each component of the training device 400 may communicate with one another through a communication bus 450. Some (e.g., the communication module 430 or the storage module 440) of the components may be omitted from the training device 400 or another component may be added to the training device 400.

The processor 410 may control the other components (e.g., a hardware or software component) of the training device 400 and may perform various types of data processing or operations. In an embodiment, as at least a part of data processing or operations, the processor 410 may store instructions or data received from another component in the memory 420, may process the instructions or the data stored in the memory 420, and may store result data in the memory 420.

The processor 410 may include any one of, or any combination of, a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently of or in conjunction with the main processor.

The memory 420 may store various pieces of data used by a component (e.g., the processor 410 or the communication module 430) of the training device 400. The various pieces of data may include, for example, a program (e.g., an application) and input data and/or output data for a command related thereto. The memory 420 may store instructions executable by the processor 410. The memory 420 may include a volatile memory or a non-volatile memory (but not a signal per se).

The communication module 430 may support the establishment of a direct (or wired) communication channel or a wireless communication channel between the training device 400 and another device and may support the communication through the established communication channel. The communication module 430 may include a communication circuit for performing a communication function. The communication module 430 may include a CP that operates independently of the processor 410 and supports direct (e.g., wired) or wireless communication. The communication module 490 may include a wireless communication module (e.g., a Bluetooth™ communication module, a cellular communication module, a Wi-Fi communication module, or a global navigation satellite system (GNSS) communication module) that performs wireless communication or a wired communication module (e.g., a local area network (LAN) communication module or a power line communication (PLC) module).

The storage module 440 may store data. The storage module 440 may store training data (e.g., sensor data) used to train the feature-type selection model. The storage module 440 may include a computer-readable storage medium. The computer-readable storage medium may include, for example, a solid-state drive (SSD), a hard disk, a compact disc read only memory (CD-ROM), a digital versatile/video disc (DVD), a flash memory, a floptical disk, a storage device, or a cloud device, or any combination thereof.

In an embodiment, the processor 410 may extract a feature from each piece of sensor data that is training data stored in the storage module 440. The sensor data may include, for example, image data obtained by an image acquisition device and point cloud data obtained by a LIDAR sensor. The processor 410 may extract a feature from each of the image data and the point cloud data. The processor 410 may determine candidate features based on the features extracted from each piece of sensor data. The candidate features may include a feature generated by combining (or synthesizing) the features extracted respectively from pieces of sensor data (combining may be concatenating the candidate features). The processor 410 may obtain a prediction result of object detection according to each candidate feature. The training device may obtain the prediction result of object detection based on the candidate feature by each modality. Each feature-type (e.g., the feature extracted from the image data or the feature extracted from the point cloud data) of each candidate feature may have an object detection model that outputs the prediction result of object detection, and a candidate feature corresponding to each object detection model may be input to each object detection model.

The processor 410 may train the feature-type selection model based on the obtained prediction result of object detection. The processor 410 may determine a loss reflecting by comparing the prediction result (e.g., a prediction result based on the feature extracted from the image data or a prediction result based on the feature extracted from the point cloud data) according to the feature-type of each candidate feature with a GT. A feature-type having the smallest loss among the feature-types selectable by the feature-type selection model may be determined to be a target feature-type that the feature-type selection model should select, and the target feature-type selected as such may be used as a label for training the feature-type selection model.

The processor 410 may optimize the feature-type selection model based on an objective function. The objective function may be a loss function or a cost function. The processor 410 may calculate a loss between the target feature-type determined by the feature-type selection model and the label determined above and may train the feature-type selection model based on the calculated loss. The processor 410 may update parameters of the feature-type selection model such that a loss decreases through an error backpropagation algorithm.

The processor 410 may optimize the feature-type selection model by performing the training process described above on multiples pieces/samples of training sensor data.

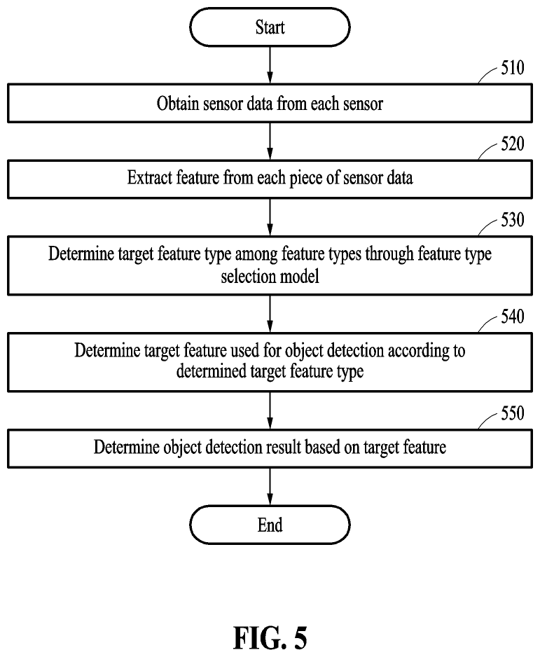

FIG. 5 illustrates an example object detection method, according to one or more embodiments. The object detection method may be performed by any of the object detection apparatuses described herein (e.g., the object detection apparatus 110 of FIG. 1 or the object detection apparatus 700 of FIG. 7).

Referring to FIG. 5, in operation 510, the object detection apparatus may obtain sensor data from each of different sensor types. The object detection apparatus may obtain first-sensor data from a first sensor (e.g., the first sensor 120 of FIG. 1 or the first sensor 740 of FIG. 7) and may obtain second-sensor data from a second sensor (e.g., the second sensor 130 of FIG. 1 or the second sensor 750 of FIG. 7) that is different (e.g., a different type of sensor) from the first sensor. The first sensor may be, for example, an image capturing device that outputs image data as the first sensor data, and the second sensor may be a LIDAR sensor that outputs point cloud data as the second sensor data, to name some non-limiting examples. The first sensor data and the second sensor data may be obtained by sensing the same scene or overlapping portions of scenes through the different sensors (i.e., the first and second sensor's sensing areas may overlap).

In operation 520, the object detection apparatus may extract a feature from each piece of sensor data. The object detection apparatus may extract a first feature from the first sensor data and a second feature from the second sensor data. The object detection apparatus may extract a feature of each feature-type (although in some embodiments a feature-type may correspond to a combination of extracted features).

In operation 530, the object detection apparatus may determine a target feature-type among the feature-types through a feature-type selection model (e.g., the feature-type selection model 340 of FIG. 6). The feature-type selection model may receive the first feature and the second feature as inputs and perform inference thereon. The feature-type selection model may receive features of each respective feature-type (e.g., of the respective sensors) and may output a predicted target feature-type. The predicted target feature-type (more directly, its corresponding object detection modality/method) is predicted to provide the most accurate object detection for the first feature and the second feature (although both might not necessarily be used for the object detecting).

In an embodiment, the feature-type selection model, based on the first and second features that are input to the feature-type selection model, may output selection data indicating which, from among the following, is selected as the target feature-type: a first feature-type (the first feature but not the second feature); a second feature-type (the second feature but not the second feature; and a third feature-type (a synthesis/combination of the first feature and the second feature). Alternatively, the feature-type selection model, based on the first and second features, may output data indicating a probability value of the target feature-type being the first, second, or third feature-type.

In operation 540, the object detection apparatus may determine a target feature to be used for object detection according to the target feature-type determined by operation 530. In an embodiment, the object detection apparatus may the feature-type having the highest probability value (among probability values outputted by the feature-type selection model for the respective feature-types). When the target feature-type is determined to be the first feature-type, the first feature may be determined to be the target feature. When the target feature-type is determined to be the second feature-type, the second feature may be determined to be the target feature. When the third feature-type is determined to be the target feature-type, the object detection apparatus may generate the third feature by synthesizing/combining the first feature with the second feature as the target feature. The third feature may be synthesized in various methods. For example, the third feature may be generated by adding a result value of multiplying a weight (e.g., 0.5) by respective vectors (or feature maps) of the first feature and the second feature (in a case where the features are extracted as feature vectors or feature maps). Alternatively, the third feature may be obtained from a decoder (e.g., the decoder 362 of FIG. 6) of a transformer model by inputting keys corresponding respectively to the first feature and the second feature and values associated respectively with the keys to the decoder.

In operation 550, the object detection apparatus may determine an object detection result based on the determined target feature. The object detection result may include information on the position/direction/size of an object area and/or object classification. The object detection apparatus may input the target feature to an object detection model and may obtain the object detection result from the object detection model. The determined target feature to an object detection model corresponding to the target feature-type of the determined target feature. The object detection result may be obtained by using the target feature that corresponds to the target feature-type determined by the feature-type selection model. Alternatively, the object detection result may be determined by using a first candidate object detection result determined based on the first feature, a second candidate object detection result determined based on the second feature, a third candidate object detection result determined based on the third feature, and the probability value obtained from the feature-type selection model. The feature-type selection model may output a probability value corresponding to each feature-type, and the object detection result may be determined by summing up all result values of probability values corresponding respectively to the feature-types by respective candidate object detection results according to the feature-types.

As described above, an object detection result may be determined by determining a target feature after determining a target feature-type. Or, an object detection result corresponding to a target feature-type in an object detection result for each feature-type may be selected as a final object detection result after the determining of the target feature-type and the determining of the object detection result for each feature-type are performed simultaneously.

The object detection apparatus may select a modality that is advantageous for each situation or each task from among modalities corresponding to various feature-types using methods through the feature-type selection model and may perform object detection based on the selected modality. The selective use of modalities as such may increase the accuracy of object detection.

FIG. 6 illustrates an example of determining or selecting an object detection result by using the feature-type selection model, according to an embodiment.

FIG. 6 illustrates detecting an object based on the object detection model with a transformer architecture, as illustrated in FIG. 3. The transformer model may provide a prediction result related to object detection corresponding to the number of queries 630 in one frame. The queries 630 may be, for example, a 1D vector and may include information about a certain object (e.g., the single 1D vector of a target feature-type 640, discussed below). The object detection process illustrated in FIG. 6 may be performed by the object detection apparatus (e.g., the object detection apparatus 110 of FIG. 1 or the object detection apparatus 700 of FIG. 7) described herein. The feature-type selection model 340 shown in FIG. 6 may be the same as that of FIG. 3, after training has been completed (or reached a certain stage or state).

The object detection process may include processes 610, 650, and 660. In process 610, the feature-type selection model 340 determines the target feature-type 640 based on features 622 and 624 extracted from sensor data in process 610. In process 650, candidate features are generated based on the features 622 and 624. And in process 660, a prediction result 670 of object detection corresponding to each candidate feature is determined by using object detection models 382, 384, and 386, and a final prediction result 680 is determined based on the prediction result 670 and the target feature-type 640. In one or more embodiments, the first feature 622 is (or is extracted from) image data obtained from an image acquisition device, the second feature 624 is (or is extracted from) a feature of point cloud data obtained from a LiDAR sensor, and a third feature (which may be considered to be a third feature-type) is a combination/synthesis of the first and second features 622, 624. However, these are non-limiting examples.

In process 610, keys respectively corresponding to the queries 630, as well as the first feature 622, and the second feature 624 and values associated respectively with the keys may be input to the feature-type selection model 340. The feature-type selection model 340 may have been trained according to the training process described with reference to FIG. 3. The feature-type selection model 340 may predict and output the target feature-type (or a target modality) 640 for the queries 630 based on the first and second features 622, 624. The feature-type selection model 340 may determine, for example, whether to use only the first feature 622, only the second feature 624, or both the first feature 622 and the second feature 624 for object detection and, to that end, may output a determined result as the target feature-type 640 (e.g., an indication thereof). For example, the feature-type selection model 340 may determine and output a target feature-type for each query. Specifically, as a non-limiting example, the feature-type selection model 340 may output a value 1 for a feature-type determined to be the target feature-type and may output 0 for the rest of the feature-types. For another example, the feature-type selection model 340 may output a probability value corresponding to each feature-type for each query. The probability value may be a degree to which a prediction result of object detection according to each feature-type should be reflected in a final prediction result.

The target feature-type 640 that is output from feature-type selection model 340 may include a target feature-type determined for each of the queries 630. For example, a feature-type FT3 in the first place of the target feature-type 640 may be a target feature-type determined by the feature-type selection model 340 for a first query, a feature-type FT1 in the second place of the target feature-type 640 may be a target feature-type determined by the feature-type selection model 340 for a second query, and a feature-type FT2 in the fourth place of the target feature-type 640 may be a target feature-type determined by the feature-type selection model 340 for a fourth query. In this case, the feature-type FT1 may correspond to a modality using both the first feature 622 and the second feature 624, the feature-type FT2 may correspond to a modality using only the first feature 622, and the feature-type FT3 may correspond to a modality using only the second feature 624.

In process 650, various candidate features may be generated. There may be the decoders 362, 364, and 366 of which the number is less than or equal to the number of feature-types. The decoders 362, 364, and 366 may correspond to decoders of the transformer model. All of the queries 630 may be input to each of the decoders 362, 364, and 366, as well as features of the respectively corresponding feature-types. The keys respectively corresponding to the first feature 622 and the second feature 624 and the values associated respectively with the keys may be input to the decoder 362, and a candidate feature of a feature-type (e.g., a first feature-type) using the first feature 622 and the second feature 624 may be output from the decoder 362. That is to say, the candidate feature may be a feature generated by combining or synthesizing the first feature 622 with the second feature 624. Similarly, the key corresponding to the first feature 622 and the value associated with the key may be input to the decoder 364, and a candidate feature of a feature-type using only the first feature 622 (without using the second feature 624) may be output from the decoder 364. In addition, the key corresponding to the second feature 624 and the value associated with the key may be input to the decoder 366, and a candidate feature of a feature-type using only the second feature 624 (without using the first feature 622) may be output from the decoder 366.

In process 660, decoded candidate features (e.g., a kind of vector value) output respectively from the decoders 362, 364, and 366 may be input respectively to the object detection models 382, 384, and 386. Each of the object detection models 382, 384, and 386 may output a respective portion of the prediction result 670 of object detection based on the respectively inputted candidate features. The prediction result 670 may include, for example, prediction information of the classification of objects and/or an object area.

In the example shown in FIG. 6, noting that “D” represents a “detection”, the object detection model 382 outputs first prediction results {D11, D12, D13, D14, D15} for the respective input queries 630, the object detection model 384 outputs second prediction results {D21, D22, D23, D24, D25} for the input queries 630, and the object detection model 386 outputs prediction third results {D31, D32, D33, D34, D35} for the input queries 630. The first, second, and third prediction results may respectively correspond to the feature-types FT1, FT2, and FT3. Each of {D11, D21, D31}, {D12, D22, D32}, {D13, D23, D33}, {D14, D24, D34}, and {D15, D25, D35} may be prediction results corresponding to the respective input queries 630.

The object detection apparatus may determine the final prediction result 680, which may be, for example, a detection of an object, for example, a probability of a location of an object (that is detected and/or recognized) and/or a recognition result (e.g., a category, class, or characteristic of the object), and so forth. The final prediction result 680 may be used, for example, by an ADAS system for making a driving decision, generating a driving plan, and so forth.

The final prediction result 680 may be determined from the prediction result 670, and that determining may be based on the target feature-type 640. That is, the target feature-type 640 may control which of the prediction results in the prediction result 670 are outputted as a final object detection result. In the example of FIG. 6, the feature-type selection model 340 is assumed to determine, as the target feature-type, the feature-types FT3, FT1, FT3, FT2, and FT1 for the respective queries 630. In this example, the object detection apparatus may determine, to be the final prediction results for the respective first to fifth queries:
(1) the prediction result D31 derived by using the second feature 624 according to the determined feature-type FT3,
(2) the prediction result D12 derived by using both the first feature 622 and the second feature 624 according to the determined feature-type FT1,
(3) the prediction result D33 derived by using the second feature 624 according to the determined feature-type FT3,
(4) the prediction result D24 derived by using the first feature 622 according to the determined feature-type FT2, and
(5) the prediction result D15 derived by using both the first feature 622 and the second feature 624 according to the determined feature-type FT1 to be a final prediction result for the fifth query. Specifically, the final prediction result 680 corresponding to the queries 630 may be determined by selecting, for a given query, whichever target feature-type 640 has been determined (by the feature-type selection model 340) to be the best (most probable) feature-type to use for object detection for that given query. In the case of the example first query, feature-type FT3 has been selected/predicted (by feature-type selection model) as optimal for object detection for the first query and for the first and second features 622, 624. Therefore, the output of the object detection model 382 that corresponds to the predicted feature-type (FT3). In short, the feature-type selection model 340 and the object detection models 382, 384, and 386 receive the same input first and second features 622, 624 (which may be different types of data, e.g., from different types of sensors), and the feature-type selection model predicts/selects which object detection model's object-detection output should be used for the input first and second features.

As conditions change, the system is able to switch between object detection models to use the object detection model most suitable at the present (e.g., for the current input features). Moreover, in some embodiments, for example when processing real-time streaming data from the sensors (e.g., video), the object detection models are repeatedly performing object detection on their respective features, regardless of whether their object detection results are being used. Thus, when conditions change and the object detection model triggers a switch from one object detection model to another, since the new “active” object detection model is repeatedly performing object detection regardless of whether it is selected/active for any given first and second features, when a next first and second feature cause the new object detection model to be active/selected, its object detection results are immediately available. In other words, two object detection models may be continuously inferring object detection results, and which one's results are outputted/used (e.g., for ADAS) may change by simply selecting one model's already-available detection results or the other's.

FIG. 7 illustrates an example configuration of the object detection apparatus, according to one or more embodiments.

Referring to FIG. 7, the object detection apparatus 700 (e.g., the object detection apparatus 110 of FIG. 1) may be a device that performs object detection based on sensor data. The object detection apparatus 700 may include a processor 710, a memory 720, and a communication module 730. According to an embodiment, the object detection apparatus 700 may further include the first sensor 740 (e.g., the first sensor 120 of FIG. 1) and the second sensor 750 (e.g., the second sensor 130 of FIG. 1). Each component of the object detection apparatus 700 may communicate with one another through a communication bus 760. In an embodiment, some of the components may be omitted from the object detection apparatus 700, or another component may be added to the object detection apparatus 700.

The processor 710 may control the other components (e.g., a hardware or software component) of the object detection apparatus 700 and may perform various types of data processing or operations. In an embodiment, as at least a part of data processing or operations, the processor 710 may store instructions or data received from another component in the memory 720, process the instructions or the data stored in the memory 720, and store result data in the memory 720.

The processor 710 may include a main processor (e.g., a CPU or an AP) and/or an auxiliary processor (e.g., a GPU, an NPU, an ISP, a sensor hub processor, or a CP) that is operable independently of or in conjunction with the main processor.

The memory 720 may store various pieces of data (e.g., sensor data) used by a component (e.g., the processor 710 or the communication module 730) of the object detection apparatus 700. The various pieces of data may include, for example, a program (e.g., an application) and input data and/or output data for a command related thereto. The memory 720 may store instructions executable by the processor 710. The memory 720 may include a volatile memory or a non-volatile memory (but not a signal per se).

The communication module 730 (e.g., network interface card, bus interface, etc.) may support the establishment of a direct (or wired) communication channel or a wireless communication channel between the object detection apparatus 700 and another device and may support the communication through the established communication channel. The communication module 730 may include a communication circuit for performing a communication function. The communication module 730 may include a CP that operates independently of the processor 710 and supports direct (e.g., wired) or wireless communication. The communication module 790 may include a wireless communication module (e.g., a Bluetooth™ communication module, a cellular communication module, a Wi-Fi communication module, or a GNSS communication module) that performs wireless communication or a wired communication module (e.g., a LAN communication module or a PLC module).

When the computer-readable instructions stored in the memory 720 are executed by the processor 710, the processor 710 may perform the operations described below. The processor 710 may receive first sensor data obtained from the first sensor 740 and second sensor data obtained from the second sensor 750 that is different from the first sensor. The first sensor 740 may be, for example, an image capturing device that outputs image data as the first sensor data, and the second sensor 750 may be a LiDAR sensor that outputs point cloud data as the second sensor data. The processor 710 may extract a first feature from the first sensor data and a second feature from the second sensor data. The processor 710 may extract a feature by each feature-type. The processor 710 may determine a target feature-type among feature-types through a feature-type selection model (e.g., the feature-type selection model 340 of FIG. 6). In an embodiment, the feature-type selection model, based on the first feature that is input to the feature-type selection model and the second feature that is input to the feature-type selection model, may output selection data indicating which one is selected as the target feature-type from among a first feature-type using only the first feature of the first feature and the second feature, a second feature-type using only the second feature of the first feature and the second feature, and a third feature-type using a third feature generated by synthesizing the first feature with the second feature. Alternatively, the feature-type selection model, based on the first feature that is input to the feature-type selection model and the second feature that is input to the feature-type selection model, may output data indicating a probability value of being selected as the target feature-type for each of the first feature-type using only the first feature of the first feature and the second feature, the second feature-type using only the second feature of the first feature and the second feature, and the third feature-type using the third feature generated by synthesizing the first feature with the second feature.

The processor 710 may determine a target feature used for object detection according to the target feature-type determined by the feature-type selection model. The processor 710 may determine, to be the target feature-type, a feature-type of which a probability value is the greatest among probability values respectively for the feature-types that are output by the feature-type selection model. The processor 710 may determine an object detection result based on the determined target feature. In an embodiment, the processor 710 may determine the object detection result by using a first candidate object detection result determined based on the first feature, a second candidate object detection result determined based on the second feature, a third candidate object detection result determined based on the third feature, and the probability value obtained from the feature-type selection model. When the third feature-type using both the first feature and the second feature is determined to be the target feature-type, the processor 710 may generate the third feature by synthesizing the first feature with the second feature as the target feature. The processor 710 may input the target feature to an object detection model and may obtain the object detection result from the object detection model. The processor 710 may obtain the object detection result from the object detection model by inputting the determined target feature to an object detection model corresponding to the target feature-type of the determined target feature. The object detection result may include information on the position/direction/size of an object area and/or object classification.

The computing apparatuses, the vehicles, the electronic devices, the processors, the memories, the image sensors, the vehicle/operation function hardware, the ADAS/AD systems, the displays, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-Res, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An object detection method comprising:
obtaining first-sensor data from a first sensor and obtaining second-sensor data from a second sensor, wherein the first sensor is a different type of sensor than the second sensor;
extracting a first feature from the first-sensor data and extracting a second feature from the second-sensor data;
determining a target feature-type by inputting the first and second features to a feature-type selection model which, based thereon, predicts the target feature-type;
determining a target feature to be used for object detection according to the determined target feature-type; and
determining an object detection result based on the determined target feature.

2. The object detection method of claim 1, wherein
the first sensor is an image capturing device configured to output image data as the first-sensor data, and
the second sensor is a light detection and ranging (LiDAR) or RADAR sensor configured to output point cloud data as the second-sensor data.

3. The object detection method of claim 1, wherein the feature-type selection model is configured to,
based on the first feature that is input to the feature-type selection model and the second feature that is input to the feature-type selection model,
output selection data controlling selection of:
object detection using the first feature and not the second feature,
object detection using the second feature and not the first feature, and
object detection using the first feature with the second feature.

4. The object detection method of claim 1, wherein the feature-type selection model is configured to,
based on the first feature that is input to the feature-type selection model and the second feature that is input to the feature-type selection model,
output probability values of a first and second feature-type, respectively, the first feature-type corresponding to performing object detection using the first feature and not the second feature, and the second feature-type corresponding to performing object detection using the second feature and not the first feature.

5. The object detection method of claim 4, further comprising selecting, as the target feature-type, from among the first and second feature-types, whichever has the greatest among the probability values.

6. The object detection method of claim 4, wherein the determining the object detection result comprises:
selecting, from among a first candidate object detection result determined based on the first feature and not the second feature, and a second candidate object detection result determined based on the second feature and not the first feature.

7. The object detection method of claim 1, further comprising:
based on the determining of the target feature-type:
generating a third feature by synthesizing or combining the first feature with the second feature as the target feature.

8. The object detection method of claim 1, wherein the object detection result from the object detection model is obtained by inputting the determined target feature to an object detection model based on the object detection model corresponding to the target feature-type.

9. The object detection method of claim 1, wherein the determining the object result based on the determined target feature comprises:
selecting, as the object detection result, between (i) a first object detection result inferred by a first object detection model from the first feature but not from the second feature and (ii) a second object detection result inferred by a second object detection model from the second feature but not from the first feature.

10. An object detection apparatus comprising:
one or more processors; and
a memory storing instructions configured to cause the one or more processors to:
obtain first-sensor data from a first sensor and obtain second-sensor data from a second sensor that is a different type of sensor than the first sensor;
extract a first feature from the first-sensor data but not from the second-sensor data, and extract a second feature from the second-sensor data but not from the first-sensor data;
determine a target feature-type through a feature-type selection model having the first feature and the second feature as an input;
determine a target feature to be used for object detection according to the determined target feature-type; and
determine an object detection result based on the determined target feature.

11. The object detection apparatus of claim 10, wherein
the first sensor is an image capturing device configured to output image data as the first sensor data, and
the second sensor is a light detection and ranging (LiDAR) or RADAR sensor configured to output point cloud data as the second sensor data.

12. The object detection apparatus of claim 10, wherein the feature-type selection model is configured to,
based on the first feature that is input to the feature-type selection model and the second feature that is input to the feature-type selection model with the first feature,
output selection data controlling selection of:
object detection using the first feature and not the second feature, and
object detection using the second feature and not the first feature.

13. The object detection apparatus of claim 10, wherein the feature-type selection model is configured to,
based on the first feature that is input to the feature-type selection model and the second feature that is input to the feature-type selection model,
output data indicating probability values of a first and second feature-type, respectively, the first feature-type corresponding to performing object detection using the first feature and not the second feature, and the second feature-type corresponding to performing object detection using the second feature and not the first feature.

14. The object detection apparatus of claim 13, wherein the instructions are further configured to cause the one or more processors to
select, as the target feature-type, from among the first and second feature-types, whichever has the greatest among the probability values.

15. The object detection apparatus of claim 13, wherein the instructions are further configured to cause the one or more processors to
select between a first candidate object detection result determined based on the first feature and not the second feature, and a second candidate object detection result determined based on the second feature and not the first feature.

16. The object detection apparatus of claim 10, wherein the instructions are further configured to cause the one or more processors to,
based on the determining of the target feature-type, generate a third feature by synthesizing or combining the first feature with the second feature as the target feature.

17. The object detection apparatus of claim 10, wherein the object detection result from the object detection model is obtained by inputting the determined target feature to an object detection model based on the object detection model corresponding to the determined target feature-type.

18. A vehicle system comprising:
a first sensor configured to obtain image data capturing an area near a vehicle;
a second sensor configured to radiate electromagnetic energy in the area near the vehicle and obtain point cloud data based on a reflection of the electromagnetic energy from an object in the area; and
one or more processors configured to detect the object based on the image data and the point cloud data by:
extracting a first feature from the image data and extracting a second feature from the point cloud data;
performing a first inference, by a first object detection model, on the first feature but not on the second feature, to generate a first object detection result;
performing a second inference, by a second object detection model, on the second feature but not the first feature, to generate a second object detection result;
input the first feature with the second feature to a selection model, the selection model inferring an output from the first feature and the second feature; and
based on the output, select between the first object detection result and the second object result as an object detection result corresponding to the object.

19. The vehicle system of claim 18, wherein the output of the selection model comprises a first probability value corresponding to the first object detection model and a second probability value corresponding to the second object detection model, and wherein
whichever of the first and second object detection results' object detection model has the higher probability value is selected as the object detection result.

20. The vehicle system of claim 18, wherein the one or more processors are further configured to
perform a third inference, by a third object detection model, on a combination or synthesis of the first feature with the second feature, to generate a second object detection result; and
wherein the selecting based on the output comprises selecting between the first, second, and third object detection results.
